(19) United States
(12) Patent Application Publication
(10) Pub. No.: US 2015/0246785 A1
(43) Pub. Date: Sep. 3, 2015

(54) SHEET FEEDING DEVICE, AND IMAGE PROCESSING SYSTEM

(71) Applicant: FUJI XEROX CO., LTD., Tokyo (JP)

(72) Inventor: Yuichi ADACHI, Kanagawa (JP)

(21) Appl. No.: 14/488,752

(22) Filed: Sep. 17, 2014

(30) Foreign Application Priority Data
Mar. 3, 2014 (JP) 2014-041007

(51) Int. Cl. B65H 7/18; B65H 1/08; B65H 7/20; B65H 5/06; B65H 7/12; G03G 15/00; B65H 3/06

(52) U.S. Cl. CPC B65H 7/18; G03G 15/50; B65H 1/08; B65H 3/0669; B65H 5/06; B65H 7/12; B65H 7/20

(57) ABSTRACT

Provided is a sheet feeding device including a tray that includes a roller that feeds a sheet to a body and a support member that supports the sheet and moves to change an interval from the roller, and a notifying unit that notifies attention calling information to check a movement state of the support member according to an opening and closing operation of the tray.

### CROSS-REFERENCE TO RELATED APPLICATIONS

This application is based on and claims priority under 35 USC 119 from Japanese Patent Application No. 2014-041007 filed Mar. 3, 2014.

### BACKGROUND

### Technical Field

The present invention relates to a sheet feeding device, and an image processing system.

### SUMMARY

According to an aspect of the invention, there is provided a sheet feeding device including:

a tray that includes a roller that feeds a sheet to a body and a support member that supports the sheet and moves to change an interval from the roller; and

a notifying unit that notifies attention calling information to check a movement state of the support member according to an opening and closing operation of the tray.

### BRIEF DESCRIPTION OF THE DRAWINGS

Exemplary embodiments of the present invention will be described in detail based on the following figures, wherein:

FIGS. 1A and 1B are schematic views of an image processing system according to a first exemplary embodiment, where FIG. 1A is a perspective view and FIG. 1B is a front view;

FIG. 2 is a block diagram of a main controller according to the first exemplary embodiment;

FIG. 3A is a perspective view of a sheet feeding tray according to the first exemplary embodiment, and FIG. 3B is a cross-sectional view;

FIG. 4 is a function block diagram for executing an attention calling control notification at the time of opening the sheet feeding tray in the main controller, according to the first exemplary embodiment;

FIGS. 5A to 5C are front views of a UI on which a pop-up menu screen is displayed on a display surface, according to the first exemplary embodiment;

FIG. 6 is a flowchart illustrating an attention calling notification control routine applied at the time of opening the sheet feeding tray according to the first exemplary embodiment;

FIG. 7 is a front cross-sectional view of a sheet feeding tray according to a second exemplary embodiment; and

FIG. 8 is a flowchart illustrating an attention calling notification control routine applied at the time of closing the sheet feeding tray according to the second exemplary embodiment.

### DETAILED DESCRIPTION

### First Exemplary Embodiment

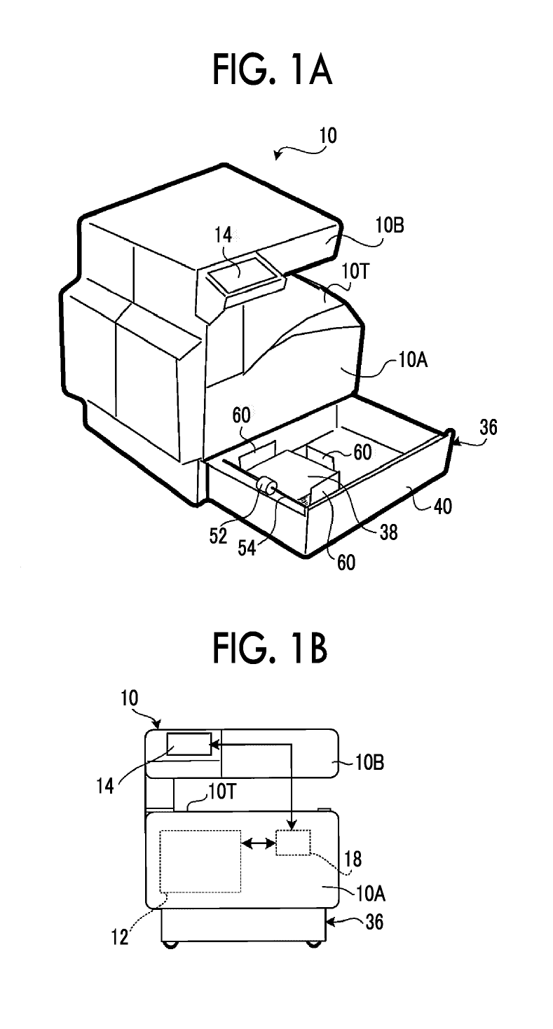

FIGS. 1A and 1B illustrate an image processing system 10 according to this exemplary embodiment.

The image processing system 10 includes an image forming section 12 (see FIG. 1B) which forms an image on a recording sheet.

The image forming section 12 includes a photoreceptor, and around the photoreceptor, a charging device that uniformly charges the photoreceptor, a scanning and exposing unit which scans a light beam on the basis of image data, an image developing unit which develops an electrostatic latent image formed by the scanning and exposing operation of the scanning and exposing unit, a transfer unit which transfers the developed image on the photoreceptor onto the recording sheet, and a cleaning unit which cleans the surface of the photoreceptor after the transfer are provided. On the transport path of the recording sheet, a fixing unit which fixes the image on the recording sheet after the transfer is provided.

On the upper surface of a housing 10A which accommodates the image forming section 12, an output tray 10T for the recording sheet, from which the recording sheet having the image recorded by the image forming section 12 is discharged, is formed.

In addition, in a housing 10B corresponding to the ceiling of the output tray 101, a UI touch panel 14 (hereinafter, referred to as a “UI 14”) is disposed.

As illustrated in FIG. 1B, the image processing system 10 includes a main controller 18 to control an image forming process of the image forming section 12, receive instruction information operated through the UI 14, and display information on the display surface of the UI 14.

To the main controller 18, a network communication line (not illustrated) such as the Internet is connected. The main controller 18 is, for example, connected to a PC (not illustrated) via the network communication line to receive image data.

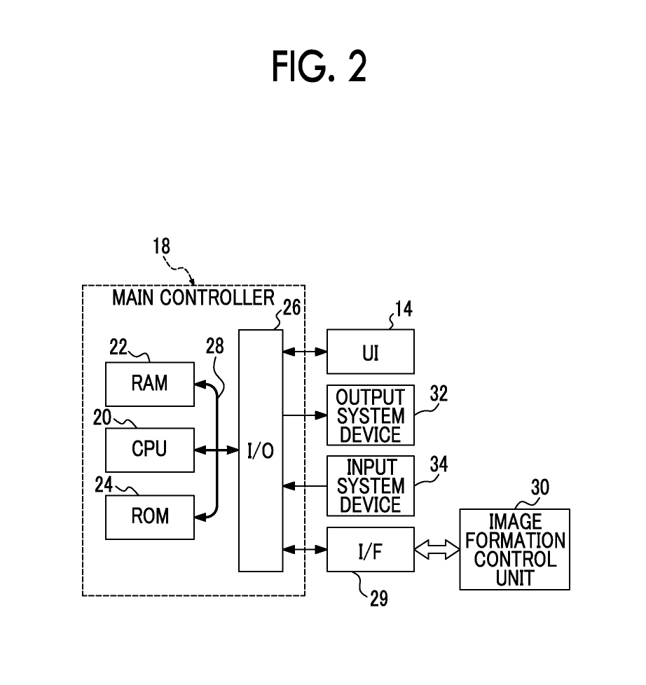

As illustrated in FIG. 2, the main controller 18 includes a CPU 20, a RAM 22, a ROM 24, an I/O 26, and buses 28 such as a data bus and a control bus for connection therebetween.

An image formation control unit 30 is connected to the I/O 26 via an I/F 29. The image formation control unit 30 controls an image processing operation of the image forming section 12 under the instruction of the CPU 20 in the main controller 18.

In addition, to the I/O 26, the UI 14 is connected, and although details are omitted, an output system device 32 including a transport system motor, and plural input system devices 34 including a sensor for detecting a position of a sheet during the transportation are connected.

As illustrated in FIG. 1A, a sheet feeding tray 36 is provided in the lower portion of the housing 10A of the image processing system 10. Recording sheets 38 are stacked in the sheet feeding tray 36 in advance. Here, as a sheet feeding function of the image processing system 10, a function of taking out the recording sheets 38 stacked in the sheet feeding tray 36 sheet by sheet in order from the recording sheet 38 at the uppermost layer so as to be fed to the image forming section 12 is provided.

The sheet feeding tray 36 has a box shape with an open upper surface, and has a so-called slide rail structure in which the sheet feeding tray 36 is drawn out manually by a user in the forward right direction of the image processing system 10 in FIG. 1A to be opened and is pushed back to be closed. In addition, the state of FIG. 1A is a state in which the sheet feeding tray 36 is “opened”.

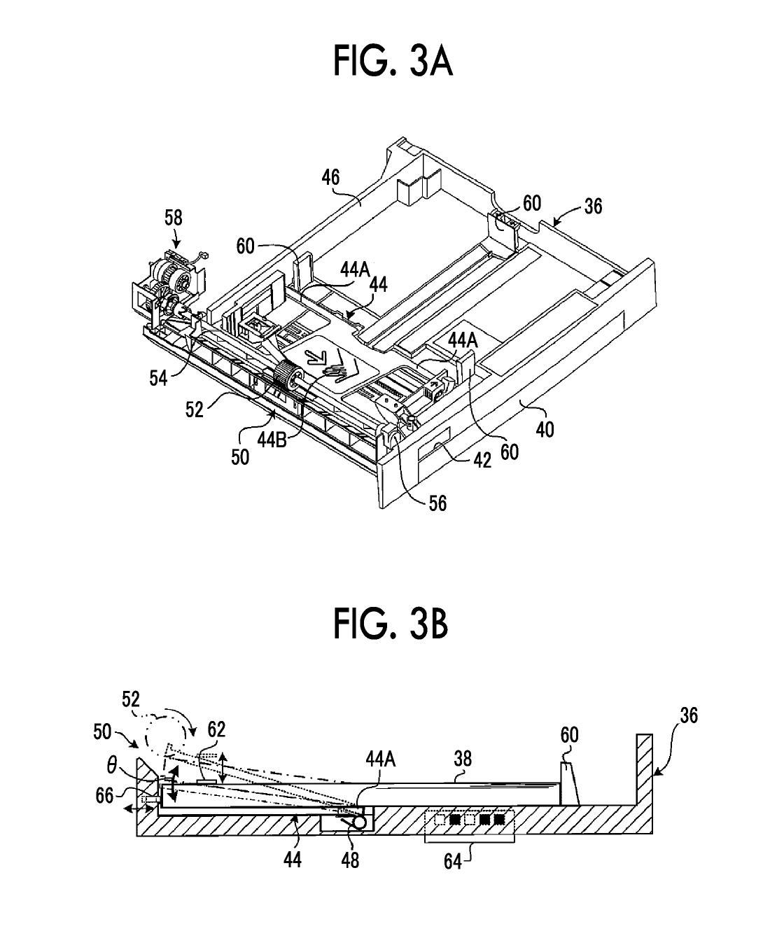

As illustrated in FIGS. 3A and 3B, the vertical wall of the sheet feeding tray 36 in the drawing direction is a housing cover 40 having a design with the same texture as the front surface of the above-mentioned housing 10A illustrated in FIG. 1A.

A grasping portion 42 which is recessed in a rectangular shape is formed in the housing cover 40. The grasping portion 42 is grasped by the user when drawing out the sheet feeding tray 36. That is, by providing the grasping portion 42 in the sheet feeding tray 36 of this exemplary embodiment, drawing-out and pushing-back operations (particularly, drawing-out operation) of the user are facilitated, compared to a case where the grasping portion 42 is absent.

The bottom surface of the sheet feeding tray 36 functions as a support surface that supports the recording sheets 38 (see FIG. 3B), and on a region of a part thereof, a bottom plate 44 is disposed.

The bottom plate 44 has a rectangular flat plate shape and is disposed at the center portion in the depth direction when the housing cover 40 is viewed from the front. In addition, the left side thereof is disposed along the left side surface of the sheet feeding tray 36.

On the right side of the bottom plate 44 of FIG. 3A, an arm portion 44A is formed along a direction from the housing cover 40 to a vertical wall portion 46 that faces the housing cover 40. The bottom plate 44 is rotated about the arm portion 44A by a predetermined angle (see the angle θ in FIG. 3B) from a state of lying on the floor surface of the sheet feeding tray 36. In addition, a torsion coil spring 48 (see FIG. 3B) is attached to the arm portion 44A, and typically, the bottom plate 44 is biased in a clockwise direction (in a direction to push up the left side) of FIG. 3B. The biasing unit is not limited to the torsion coil spring 48, and the attachment position thereof is not limited as long as the bottom plate 44 is biased in the clockwise direction in FIG. 3B about the arm portion 44A.

Therefore, in the recording sheet 38 supported by the floor surface including the bottom plate 44, a region thereof on the bottom plate 44 is pushed up (see the dot-dashed line and the dotted line of FIG. 3B).

In the sheet feeding tray 36, the left side surface thereof when the housing cover 40 is viewed from the front functions as a feeding unit 50 for feeding the recording sheet 38 to the image forming section 12, and an arc-shaped guide surface is formed to be continuous from the bottom surface thereof.

In the feeding unit 50, a feed roller 52 is disposed, and is attached to the center portion of a circular bar-shaped guide shaft 54.

Among the recording sheets 38 pushed up by the bottom plate 44, the recording sheet 38 at the uppermost layer abuts on the feed roller 52.

One end portion of the guide shaft 54 of the feed roller 52 is supported by a bracket portion 56 attached to the housing cover 40 side, and the other end portion thereof is detachably connected to the rotating shaft of a motor driving unit 58 disposed on the housing 10A side. That is, when the sheet feeding tray 36 is drawn out and is opened, the guide shaft 54 is separated from the rotating shaft of the motor driving unit 58, and when the sheet feeding tray 36 is pushed back and is closed, the guide shaft 54 and the rotating shaft of the motor driving unit 58 are connected to each other (interlocked with the opening and closing of the sheet feeding tray 36). The motor driving unit 58 belongs to the above-described output system device 32.

In the state where the sheet feeding tray 36 is closed, the recording sheets 38 are pushed up by the bottom plate 44, and the recording sheet 38 at the uppermost layer is in a state of abutting on the feed roller 52. Therefore, when the motor driving unit 58 is operated under the command of the image formation control unit 30, the feed roller 52 is rotated, and the recording sheet 38 at the uppermost layer is taken out of the sheet feeding tray 36 and is sent to the image forming section 12.

In the sheet feeding tray 36, guide plates 60 which guide the circumferential ends (circumferential ends in three directions other than the feeding unit 50) of the recording sheet 38 according to the size of the recording sheet 38 are movably mounted, and the user determines the positions of the recording sheet 38 according to the size of the recording sheet 38 supported on the floor surface.

In addition, in the sheet feeding tray 36, a sheet presence and absence sensor 62 is mounted to recognize the presence or absence of the recording sheet 38 as an electrical signal.

Furthermore, in the sheet feeding tray 36, a size determining sensor 64 (see FIG. 3B) is provided to detect an uneven state that matches the positional relationship between the guide plates 60, thereby determining the size of the stacked recording sheets 38. In addition, the size determining sensor 64 may also function as a sensor that detects the opening and closing of the sheet feeding tray 36.

The sheet presence and absence sensor 62 and the size determining sensor 64 belong to the above-mentioned input system device 34.

Here, in the sheet feeding tray 36, a lock mechanism portion 66 (see FIG. 3B) which holds the bottom plate 44 in a state of lying on the floor surface (a state of being parallel to the floor surface) against the biasing force of the torsion coil spring 48 is provided. The lock mechanism portion 66 has a structure that is locked by pressing down the bottom plate 44 (or the recording sheets 38 in a case where the recording sheets 38 are present) by the user when the sheet feeding tray 36 is opened.

In addition, the locking of the lock mechanism portion 66 is automatically released when the sheet feeding tray 36 is closed so that the bottom plate 44 may be pushed up by the torsion coil spring 48.

In the above description, there may be cases where the sheet feeding tray 36 is drawn out when the user replenishes the recording sheets 38 or due to some error (jammed paper or the like).

At this time, when the biasing force of the torsion coil spring 48 is applied to the bottom plate 44, in a case where the recording sheet 38 is absent, the bottom plate 44 is in a state of becoming closest to the feed roller 52. In a case where the recording sheets 38 are present, the recording sheets 38 are in a state of abutting on the feed roller 52.

In Case where Recording Sheets 38 are Absent

When the recording sheets 38 are to be replenished, since the bottom plate 44 is disposed at an angle with respect to the floor surface, there may be cases where the recording sheets 38 are not supported at an appropriate position. Particularly, in a case where the guide plates 60 are moved, the appropriate position may not be known.

In Case where Recording Sheets 38 are Present

There may be cases where the recording sheet 38 in a state of abutting on the feed roller 52 due to the opening and closing operation of the sheet feeding tray 36 is shifted, which may cause jammed paper when the recording sheet 38 is taken out after closing the sheet feeding tray 36.

Therefore, on the bottom plate 44, an image 44B showing a user's hand and an arrow is displayed (see FIG. 3A). However, when the recording sheet 38 is present, the image 44B is naturally invisible. In addition, even in the case where the recording sheet 38 is absent, the user may be distracted by a replenishing operation to be performed and thus the image 44B may not receive attention.

Here, in this exemplary embodiment, in the case where the sheet feeding tray 36 is drawn out, attention calling information which urges that the bottom plate 44 be pressed to be parallel to the floor surface so as to be held by the lock mechanism portion 66 is notified to the UI 14.

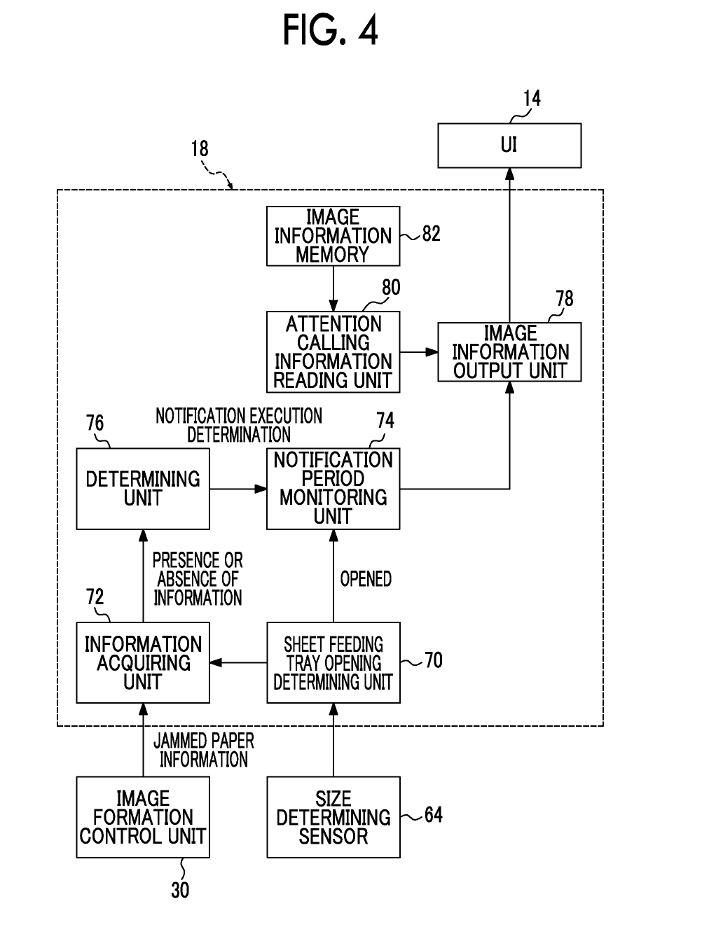

FIG. 4 shows a function block diagram for attention calling notification control at the time of opening the sheet feeding tray in the main controller 18. In addition, this block diagram does not limit the hardware configuration of the main controller 18.

The size determining sensor 64 provided in the sheet feeding tray 36 is applied as a sensor that determines the opening and closing state of the sheet feeding tray 36 and is connected to a sheet feeding tray opening determining unit 70.

The sheet feeding tray opening determining unit 70 is connected to an information acquiring unit 72 and a notification period monitoring unit 74. When the information acquiring unit 72 receives a signal indicating that the sheet feeding tray 36 is open, from the sheet feeding tray opening determining unit 70, the information acquiring unit 72 acquires information about jammed paper from the image formation control unit 30.

The information acquiring unit 72 transmits presence or absence of the jammed paper information to a determining unit 76. The determining unit 76 determines whether or not to execute the notification of attention calling information which urges that the bottom plate 44 be pushed back, on the basis of the presence or absence of the information, that is, whether or not there is jammed paper.

The determining unit 76 is connected to the notification period monitoring unit 74 and transmits the determination result to the notification period monitoring unit 74.

Here, the notification period monitoring unit 74 receives information on the opening and closing state of the sheet feeding tray 36 from the sheet feeding tray opening determining unit 70. The notification period monitoring unit 74 transmits a notification instruction signal to an image information output unit 78 during the opening of the sheet feeding tray 36 and only in a period in which there is no jammed paper.

The image information output unit 78 is connected to an attention calling information reading unit 80, and when receiving the notification instruction signal, instructs the attention calling information reading unit 80 to read image information from an image information memory 82. The image information output unit 78 receives the corresponding image information and displays an image on the UI 14.

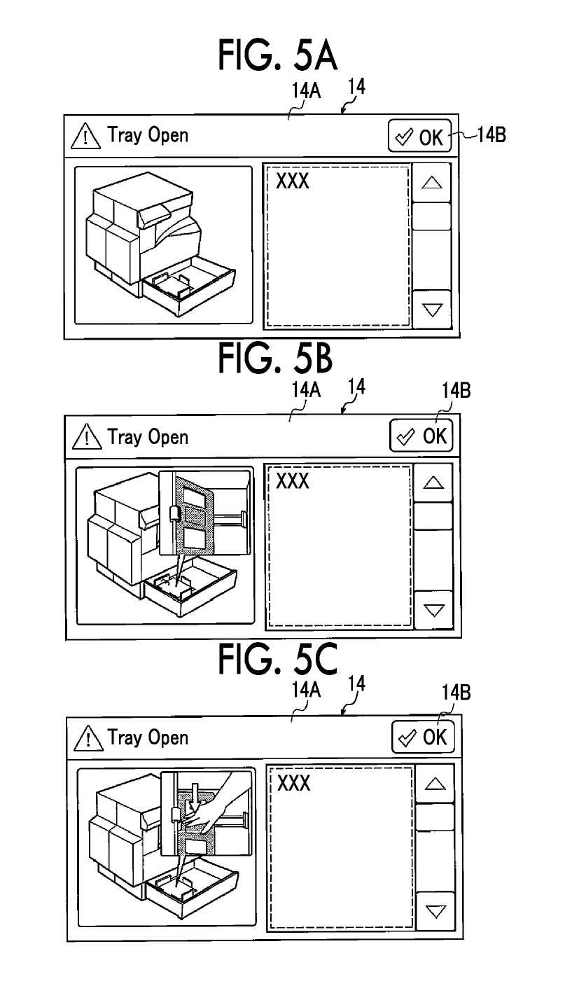

In this exemplary embodiment, as illustrated in FIGS. 5A to 5C, the display screen of the UI 14 is divided into two regions so that one region displays an image representing the image processing system 10 and three frame images which urge that the bottom plate 44 be pressed down.

In the other region, a message containing characters is displayed. The message containing characters is displayed as “XXX” in FIGS. 5A to 5C, and for example, “after pressing down the center of the bottom plate, close the tray” may be considered. On the basis of the message, when sheets are present, a message to the effect that the sheets have to be temporarily taken out may be added.

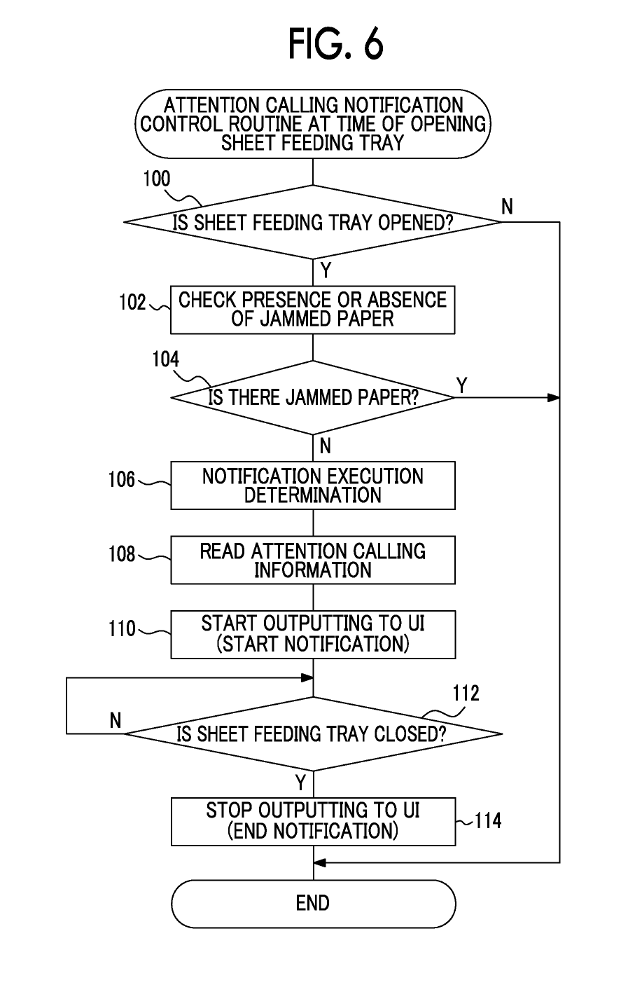

Hereinafter, the action of this exemplary embodiment will be described according to the flowchart of FIG. 6.

In Step 100, whether or not the sheet feeding tray 36 is opened is determined. When a negative determination is made, it is determined that there is no need to notify the attention calling information, and this routine is ended.

When an affirmative determination is made in Step 100, the routine proceeds to Step 102 to acquire information of the presence or absence of jammed paper from the image formation control unit 30, and the routine proceeds to Step 104 to determine whether or not there is jammed paper.

When there is an affirmative determination in Step 104, that is, jammed paper, it is determined that there is no need to notify the attention calling information so as to perform a jammed paper eliminating process first, and the routine is ended.

When a negative determination is made in Step 104, for example, it is determined that the sheet feeding tray 36 is opened to replenish the recording sheets 38 or the like, and the routine proceeds to Step 106 to perform a notification execution determination because the attention calling information needs to be notified. The routine proceeds to Step 108.

In Step 108, the attention calling information is read from the image information memory 82, and thereafter the routine proceeds to Step 110 to start outputting the corresponding attention calling information to the UI 14.

On the UI 14, first, as illustrated in FIG. 5A, a pop-up menu screen 14A is displayed on the display surface of the UI 14.

The pop-up menu screen 14A is divided into two regions so that on one region, a picture image of a state where the sheet feeding tray 36 of the image processing system 10 is opened is displayed, and on the other region, an image containing characters (for example, as a message, “after pressing down the center of the bottom plate, close the tray”) is displayed.

In this exemplary embodiment, the picture image includes three frame images. In FIG. 5B, an image showing a state where the bottom plate 44 is raised is displayed, and in FIG. 5C, an image showing a state where the user presses down the bottom plate 44 is displayed. The images are displayed in rotation in order from FIG. 5A to FIG. 5C to express a frame-stepping operation for calling attention.

In this case, the message maybe changed or the characters may be allowed to blink or to expand or contract.

As illustrated in FIG. 6, after starting outputting the attention calling information to the UI 14 in Step 110, the routine proceeds to Step 112 to determine whether or not the sheet feeding tray 36 is closed.

When an affirmative determination is made in Step 112, the routine proceeds to Step 114 and the outputting of the information to the UI 14 is stopped, thereby ending the notification.

In addition, in the routine of FIG. 6, when the sheet feeding tray 36 is closed, notification of the attention calling information is automatically ended. However, it is not always that the bottom plate 44 is reliably pressed down even though the sheet feeding tray 36 is closed.

Here, an “OK” button image 14B is displayed on a part of the pop-up menu screen 14A displayed on the UI 14, and by touching the region of the “OK” button image 14B by the user, the displaying may be ended. That is, since the displaying continues even though the sheet feeding tray 36 is closed, when the attention calling information is ended by the user's intention, there is a higher possibility that the bottom plate 44 may be pressed down than a case where the displaying is automatically ended due to the closing of the sheet feeding tray 36.

### Modification Example of First Exemplary Embodiment

In the first exemplary embodiment, when the sheet feeding tray 36 is opened, the attention calling information is notified to (displayed on) the UI 14.

However, when the sheet feeding tray 36 is closed, the locking of the lock mechanism portion 66 of the bottom plate 44 is automatically released such that the bottom plate 44 is rotated in the clockwise direction of FIG. 3B (the end portion of the bottom plate 44 on the feeding unit 50 side in the sheet feeding tray 36 is raised) by the biasing force of the torsion coil spring 48.

When the bottom plate 44 is raised, if there is an obstacle in the sheet feeding tray 36, there may be cases where the obstacle abuts on the ceiling of the housing 10A of the image processing system 10 due to the raising of the bottom plate 44 and interrupts the raising of the bottom plate 44.

Representative examples of the obstacle include a spare sheet and an instruction manual.

The sheet feeding tray 36 has a size that may accommodate maximum-size recording sheets and for example, the maximum size is the A3 size. In a case where an assumed size is the A4 size, there is a margin of ½ of the region in the floor surface of the sheet feeding tray 36. Therefore, there is a possibility that the spare sheet or the instruction manual may be stored in the margin region. In this case, if the user does not pay attention to the height direction, although the sheet feeding tray 36 may be closed, the spare sheet or the instruction manual may become an obstacle in a case where a margin of about the raising range of the bottom plate 44 is not provided.

Here, in the modification example of the first exemplary embodiment, when the sheet feeding tray 36 is opened, the attention calling information to the effect that the bottom plate 44 has to be pressed down is notified, and when the sheet feeding tray 36 is closed, the attention calling information to the effect that the presence of a material that may become an obstacle in the sheet feeding tray 36 has to be considered is notified to the UI 14.

Accordingly, an opportunity to notify the calling attention associated with the opening and closing of the sheet feeding tray 36 increases, thereby increasing a degree of prevention of transport failure.

### Second Exemplary Embodiment

Next, a second exemplary embodiment will be described. In addition, like elements as those of the first exemplary embodiment are denoted by like reference numerals, and the description of the configurations thereof will be omitted.

In the second exemplary embodiment, the bottom plate 44 is raised by a driving force of a motor.

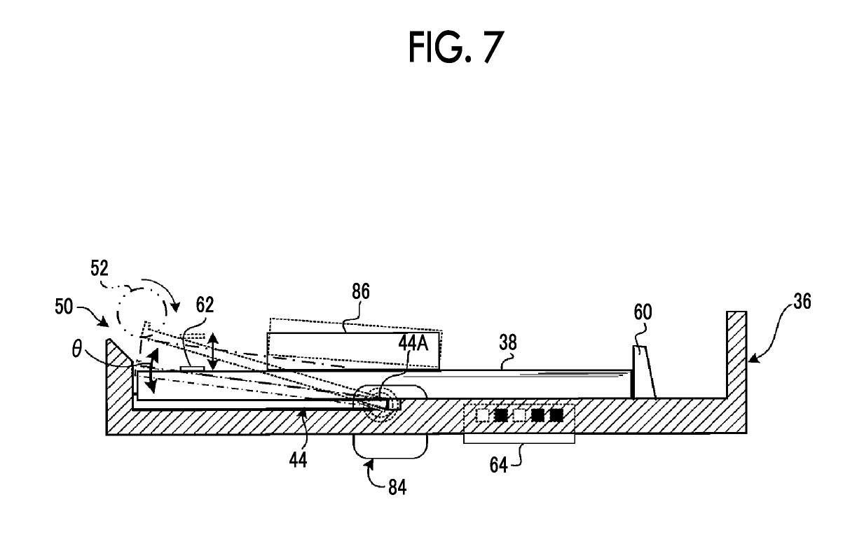

FIG. 7 is a front view of the sheet feeding tray 36 in which the bottom plate 44 is raised by the driving force of a motor 84.

The bottom plate 44 of the second exemplary embodiment is automatically lowered when the sheet feeding tray 36 is opened and is automatically raised when the sheet feeding tray 36 is closed.

Here, when the sheet feeding tray 36 is closed and thus the bottom plate 44 is automatically raised, if an obstacle 86 is present in the sheet feeding tray 36, there may be cases where the obstacle abuts on the ceiling of the housing 10A of the image processing system 10 due to the raising of the bottom plate 44 and interrupts the raising of the bottom plate 44.

Representative examples of the obstacle include a spare sheet and an instruction manual.

The sheet feeding tray 36 has a size that may accommodate maximum-size recording sheets and for example, the maximum size is the A3 size. In a case where an assumed size is the A4 size, there is a margin of ½ of the region in the floor surface of the sheet feeding tray 36. Therefore, there is a possibility that the spare sheet or the instruction manual may be stored in the margin region. In this case, if the user does not pay attention to the height direction, although the sheet feeding tray 36 maybe closed, the spare sheet or the instruction manual may become an obstacle in a case where a margin of about the raising range of the bottom plate 44 is not provided.

In the second exemplary embodiment, while the bottom plate 44 is raised and lowered, particularly, is raised by the driving force of the motor 84, when there is operation failure in which the bottom plate 44 does not reach a predetermined position (the position where the recording sheet 38 abuts on the feed roller 52) due to the obstacle 86, the operation is re-executed (re-tried) a predetermined number of times (for example, N times, N is a positive integer).

Here, when the operation failure is not eliminated by N times of execution, as a system error of the sheet feeding device, the function of the image processing system 10 itself is stopped (powered off).

While the operation failure is caused by the obstacle in the sheet feeding tray 36 and the operation failure is eliminated by a process such as removing the obstacle or lowering the height thereof, the re-execution is repeated while the user does not know the cause, and as a result, the system error is determined.

Here, in the second exemplary embodiment, in a case where the operation failure occurs at the timing of raising the sheet feeding tray 36, the attention calling information is notified to the UI 14 in stages.

For example, when there is initial operation failure, a message (for example, check the inside of the sheet feeding tray) is displayed on the UI 14 as the attention calling information. At this time, a picture image (for example, the picture image illustrated in FIG. 3A) of the sheet feeding tray 36 that is open may be displayed.

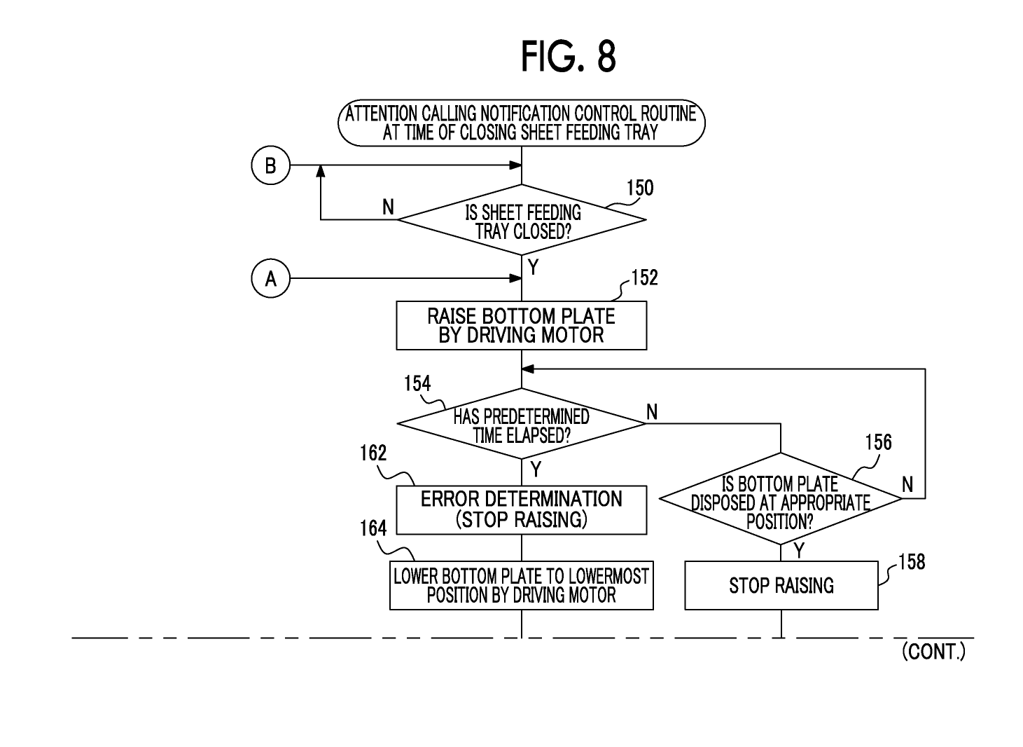

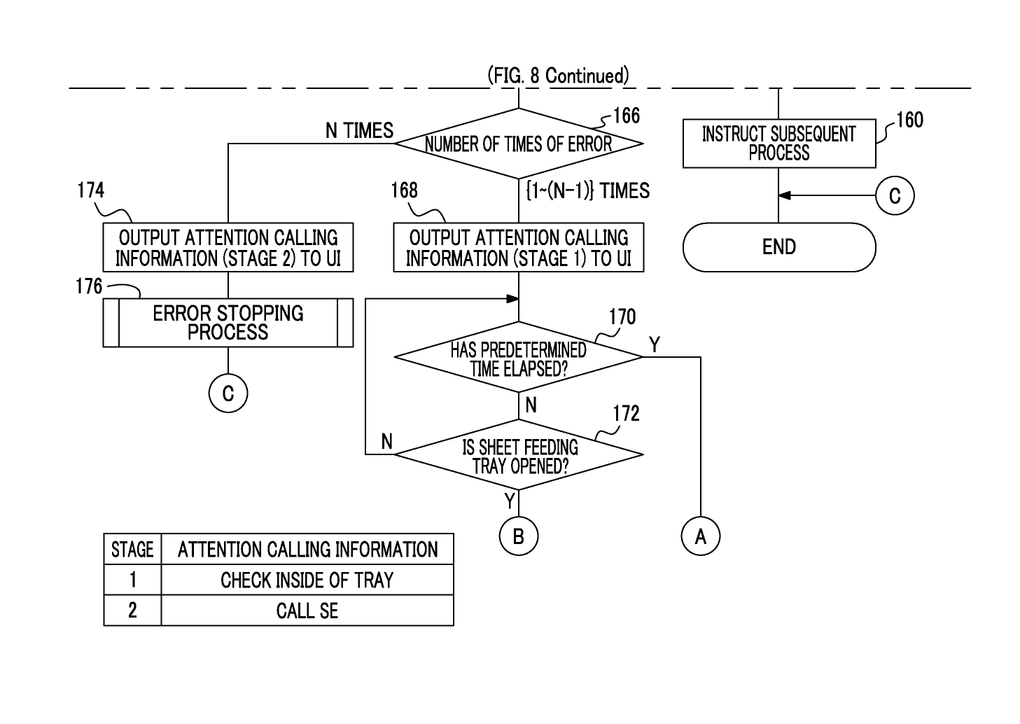

FIG. 8 is a flowchart illustrating an attention calling notification control routine applied at the time of closing the sheet feeding tray according to the second exemplary embodiment.

In Step 150, it is determined whether or not the sheet feeding tray 36 is closed. When an affirmative determination is made, the routine proceeds to Step 152 to raise the bottom plate 44 by driving the motor.

Next, in Step 154, it is determined whether or not a predetermined time has elapsed after the start of the raising of the bottom plate 44. The predetermined time is a sufficient amount of time for the bottom plate 44 to reach an appropriate position at the uppermost end.

When a negative determination is made in Step 154, the routine proceeds to Step 156 to determine whether or not the bottom plate 44 reaches the appropriate position. When a negative determination is made in Step 156, the routine returns to Step 154, and Steps 154 and 156 are repeated until an affirmative determination is made in any of Steps 154 and 156.

Here, when an affirmative determination is made in Step 156, it is determined that the bottom plate 44 reaches the appropriate position, and the routine proceeds to Step 158 to stop the raising. Thereafter, the routine proceeds to Step 160 to instruct a subsequent process, and the routine is ended.

In addition, when an affirmative determination is made in Step 154, it is determined that the bottom plate 44 has not reached the appropriate position within the predetermined time, and the routine proceeds to Step 162 to stop the raising of the bottom plate 44 as an error determination. Thereafter, the routine proceeds to Step 164 to lower the bottom plate 44 to the lowermost position by driving the motor, and proceeds to Step 166.

In Step 166, the number of times of error after closing the sheet feeding tray 36 is determined. When an N-1 number of times after the first time is determined in Step 166, the routine proceeds to Step 168 to output the attention calling information to the UI 14. The attention calling information at this time is in stage 1, and a message (for example, “check the inside of the sheet feeding tray”) is displayed as a relatively mild error, and the routine proceeds to Step 170.

As a result of the determination in Step 166, when the number of times of error reaches the N number of times, that is, the predetermined number of times of re-execution, the routine proceeds to Step 174 to output the attention calling information to the UI 14. The attention calling information at this time is in stage 2, and a message (for example, “System error. Call SE”) is displayed as a relatively serious error. Thereafter, the routine proceeds to Step 176 to execute an error stop process for the image processing system 10, and the routine is ended.

In Step 170 after displaying the mild message (stage 1) in Step 168, it is determined whether or not the predetermined time has elapsed, and when a negative determination is made, the routine proceeds to Step 172 to determine whether or not the sheet feeding tray 36 is opened. That is, in Steps 170 and 172, an extra time for an operation of checking the inside of the sheet feeding tray 36 by the user is set on the basis of the message in the stage 1.

Therefore, Steps 170 and 172 are repeated. When an affirmative determination is made in Step 170, it is determined that there is no intention for the user to open the sheet feeding tray 36 and check the inside, and the routine returns to Step 152 to repeat the affirmation.

On the other hand, when an affirmative determination is made in Step 172, it is determined that there is an intention for the user to check the inside of the sheet feeding tray 36, and the routine returns to Step 150 to repeat the affirmation.

In addition, the stages of the message is not limited to the two stages (stage 1 and stage 2), and may be set to three or more stages. In addition, the picture image may be set to a frame-stepping image showing that the obstacle 86 is removed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A sheet feeding device comprising:
a tray that includes a roller that feeds a sheet to a body and a support member that supports the sheet and moves to change an interval from the roller; and
a notifying unit that notifies attention calling information to check a movement state of the support member according to an opening and closing operation of the tray.

2. A sheet feeding device comprising:
a tray that includes a roller that feeds a sheet to a body, a support member that supports the sheet and moves to change an interval from the roller, and a biasing unit that biases the support member at least in a direction approaching the roller; and
a notifying unit that notifies attention calling information which urges that the support member to be operated in a direction away from the roller against a biasing force of the biasing unit when the tray is opened.

3. The sheet feeding device according to claim 2, further comprising:
a holding mechanism portion that holds the support member at an end in the direction away from the roller and releases the holding of the support member by being interlocked with an operation of closing the tray.

4. The sheet feeding device according to claim 2,
wherein the notifying unit notifies the attention calling information indicating a possibility that an obstacle interrupts an operation of the support member in the direction approaching the roller, when an error associated with sheet feeding occurs.

5. The sheet feeding device according to claim 3,
wherein the notifying unit notifies the attention calling information indicating a possibility that an obstacle interrupts an operation of the support member in the direction approaching the roller, when an error associated with sheet feeding occurs.

6. A sheet feeding device comprising:
a tray that includes a roller that feeds a sheet to a body and a support member that supports the sheet and moves to change an interval from the roller;
a moving unit that connects the support member to a driving source in a state where the tray is closed so as to move the support member at least in a direction approaching the roller by a driving force of the driving source; and
a notifying unit that notifies attention calling information indicating a possibility that an obstacle interrupts an operation of the support member in the direction approaching the roller, when an error associated with sheet feeding occurs.

7. The sheet feeding device according to claim 6,
wherein contents of the attention calling information of the notifying unit vary in stages whenever the moving unit is re-executed after the error occurs.

8. An image processing system comprising:
the sheet feeding device according to claim 1; and
an image forming section that forms an image at least on a recording medium.
